(19) United States
(12) Patent Application Publication
(10) Pub. No.: US 2018/0200979 A1
(43) Pub. Date: Jul. 19, 2018

(54) Walking Walls Bale Ejector

(71) Applicant: ACCENT PACKAGING, INC., TOMBALL, TX (US)

(72) Inventors: Alan R. Bergkamp, Hutchinson, KS (US); Mark Vaughn, Wyandotte, OK (US)

(73) Assignee: ACCENT PACKAGING, INC., TOMBALL, TX (US)

(21) Appl. No.: 15/405,394

(22) Filed: Jan. 13, 2017

(51) Int. Cl. B30B 9/30; A01F 15/08; A01F 15/14

(52) U.S. Cl. CPC B30B 9/3014; A01F 15/14; A01F 15/0875

(57) ABSTRACT

A walking walls bale ejector with one stationary floor wall, one horizontal and lateral moveable side wall, one horizontal moveable side wall and an upper horizontal moveable wall. The side walls and top wall can be moved horizontally in relation to the frame.

### CROSS-REFERENCE TO RELATED APPLICATIONS

Not applicable.

### STATEMENT REGARDING FEDERALLY SPONSORED RESEARCH

Not applicable.

### BACKGROUND

This invention relates generally to material balers and in particular to a system and machine for allowing a baler to eject a bale at full speed and continue baling without time impediment through the use of a walking walls ejector.

### SUMMARY

In some embodiments of the present invention, the walking walls bale ejector comprises one stationary floor wall, one horizontally and laterally moveable side wall, one horizontally moveable side wall as well as an upper horizontally moveable wall.

In some embodiments of the present invention, during operation, a bale enters the rear of the walking walls bale ejector. The side wall keeps the bale in a compressed position because the adjustable side wall is placed in the correct position to ensure that the space between the walls in the walking walls bale ejector corresponds to the size of the bale. The upper wall does not move up and down. In several preferred embodiments, the nonadjustable side wall does not move. Additional cylinders on the side walls and the upper wall can then advance the bale forward through the walking walls bale ejector in a horizontal movement.

In several embodiments of the present invention, a wire tier machine can be placed on the walking walls bale ejector distal to the actual baler. In several embodiments of the present invention, the walking walls bale ejector can be constructed with a wire tier attachment on the front side of walking walls bale ejector.

In some embodiments, one of the side walls can move on a track, or moveable mechanism, therein allowing for bales to be extruded into the walking walls bale ejector from a baler. In several embodiments side walls that can move on a track can electronically coordinate with a baler to ensure proper adjustable wall movement and positioning to accommodate the size of the bale and the timing of the bale leaving the baler and entering the walking walls bale ejector.

### BRIEF DESCRIPTION OF THE DRAWINGS

For a more complete understanding of the present disclosure and the advantages thereof, reference is now made to the following descriptions to be taken in conjunction with the accompanying drawings describing specific embodiments of the disclosure, wherein:

FIG. 1 is an isometric view of one embodiment of the present invention with the adjustable wall in the beginning operative position.

FIG. 2 is an isometric view of one embodiment of the present invention with an adjustable wall in the open position wherein the adjustable column is at maximum distance from the nonadjustable wall.

FIG. 3 is an isometric view of one embodiment of the present invention with the adjustable wall moved into a position to accommodate a bale size that was just completed by a baler.

FIG. 4 is an isometric view of one embodiment of the present invention with all adjustable walls in extended position relative to frame bars.

FIG. 5 is an isometric view of one embodiment of the present invention with the top wall in retracted position relative to frame bars.

FIG. 6 is an isometric view of one embodiment of the present invention with an adjustable wall in retracted position relative to frame bars.

FIG. 7 is an isometric view of one embodiment of the present invention with another adjustable wall in retracted position relative to frame bars.

FIG. 8 is an isometric view of one embodiment of the present invention with the adjustable wall in the beginning operative position attached to a wire tier.

FIG. 9 is an isometric view of one embodiment of the present invention with the adjustable wall in the beginning operative position, as rotated to illustrate the back portion of one embodiment of the present invention.

FIG. 10 is an isometric view of one embodiment of the present invention with the adjustable wall in the beginning operative position and a bale in the walking ejector.

FIG. 11 is another isometric view of one embodiment of the present invention, with the adjustable wall in the beginning operative position, as rotated to illustrate the back portion of one embodiment of the present invention.

### DETAILED DESCRIPTION

One or more illustrative embodiments incorporating the invention disclosed herein are presented below. Applicant has created a revolutionary walking walls bale ejector.

In the following description, certain details are set forth such as specific quantities, sizes, etc. so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Drawings are not necessarily to scale and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 11th Edition, 2008. Definitions and/or interpretations should not be incorporated from other patent applications, patents, or publications, related or not, unless specifically stated in this specification or if the incorporation is necessary for maintaining validity.

Certain terms are used in the following description and claims to refer to particular system components. As one skilled in the art will appreciate, different persons may refer to a component by different names. This document does not intend to distinguish between components that differ in name but not function. The drawing figures are not necessarily to scale. Certain features of the invention may be shown exaggerated in scale or in somewhat schematic form, and some details of conventional elements may not be shown, all in the interest of clarity and conciseness.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

“Piston” or “cylinder” as used herein is “any mechanical device used to derive motion, or in a pump to impart motion.” The two terms “piston” and “cylinder” may be used interchangeably throughout this application. The terms “bottom”, “top”, and “side” as used herein are relative to each other, in that “bottom” is parallel to “top” and a “side” is parallel to another “side”. In several embodiments of the present invention a “bottom” can be perpendicular to the ground, or even located a further distance from the ground than a “top”. “Bar” or “Bars” as defined herein can include any variety of three-dimensional shape whether as a single unit, or assembled units capable of performing the requirements of a “bar” as outlined below. “Horizontal movement” or variants thereof, is defined as a movement away from fixed point and substantially parallel to the ground upon which the frame is stationed.

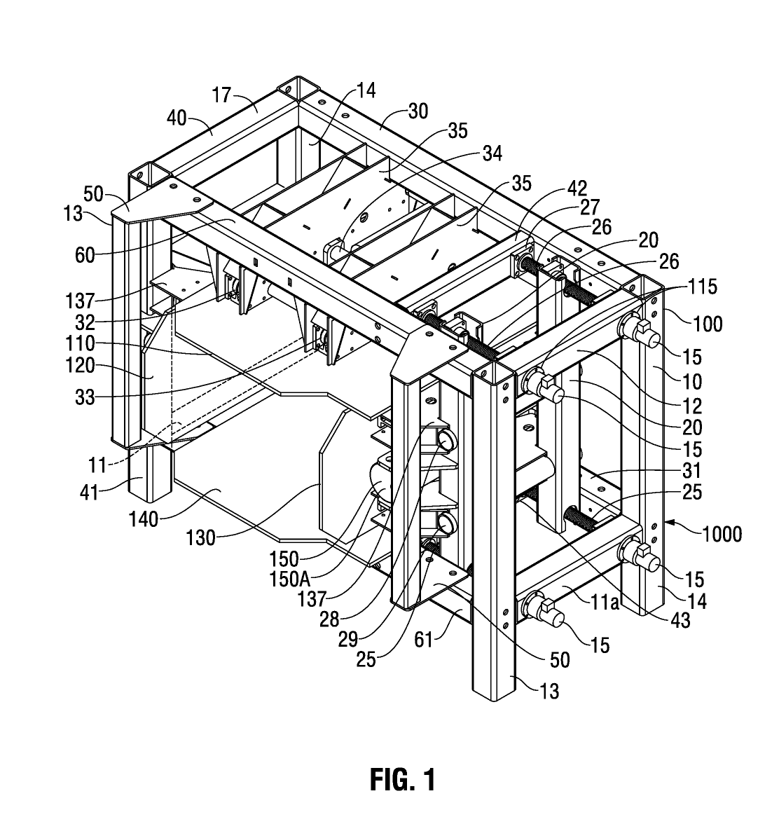

Referring to the drawings in more detail, and in particular to FIG. 1 is an isometric view of one embodiment of the present invention with the movable wall in the beginning operative position. In many embodiments, the walking walls bale ejector 1000 is primarily constructed of heavy duty parts, such as metals and alloys designed to be utilized under the pressures and weights associated with material baling.

As shown in several embodiments, walking walls ejector 1000 is comprised of a substantially rectangular hollow frame 100. Hollow frame 100 can be of variant geometric shapes provided that the shape allows for the maintenance of a compressed bale shape and bale movement capabilities as are required by further aspects of the invention. Hollow frame 100 is preferably constructed with a solid industrial metal or alloy as is known in the art of baling ejectors.

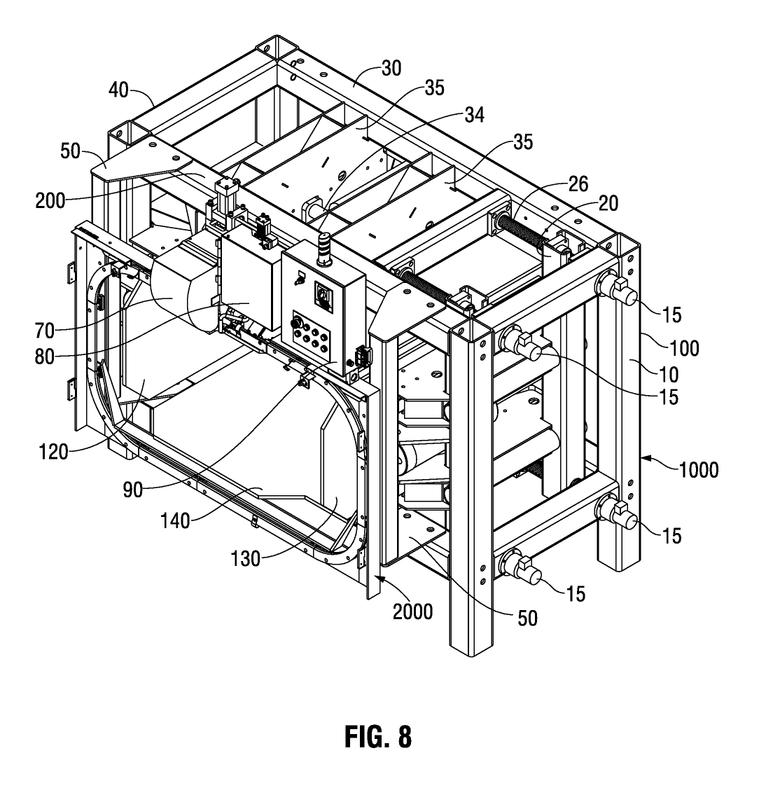

Hollow frame 100 is constructed, in many embodiments, with two side frames 40 and 10. Frames 40 and 10 are preferably constructed in a rectangular shape with top bars 17 and 12 respectively and bottom bars 11 and 11a. In many embodiments, forming the sides of frame 40 and 10 are hollow square legs 14 and 13. In several embodiments, frames 40 and 10 also mechanically attach to frame bars 30, 31, 60 and 61 in a manner known in the art for a frame utilized in baling work. All frame bars and legs are preferably constructed of a durable metal or alloy material. Attached to the front of bars 60 and 61 and distal to back bars 30 and 31 are two wire tier handle holders 50 designed to engage and hold a wire tier mechanism in several embodiments of the present invention (See FIG. 8).

In several embodiments of the present invention, bars 12 and 11a are constructed with orifices 115 running through bars 12 and 11a which can engage threaded rods 25 and 26 as well as securing rigs 15. In several embodiments of the present invention, securing rigs 15 are designed to fixedly engage threaded rods 25 and 26 to bars 11a and 12 respectively.

Rigidly located between frames 40 and 10 and in direct perpendicular mechanical attachment to rods or bars or back bars 30 and 60 and rods or bars or bars 31 and 61 are support beams 42 and 43 respectively. Support beams 42 and 43 are preferably designed to withstand the stresses of standard bale movement activities. Attached to support beam 42 through engagement faces 27, are threaded rods or bars 26. Attached to support beam 43 through engagement faces 27 are threaded rods 25. Attached between threaded rods or bars 26 and 25 are adjustable support columns 20. Adjustable support columns 20 can mechanically vary in distance between side frames 10 and supports beams 42 and 43 by rotation of threaded rods 25 and 26 respectively. In several embodiments, threaded rods 25 and 26 are mechanically secured to frame 10 via securing rigs 15.

Attached to rods or bars or back bars 30 and front bar 60 and distal to frame 10 are baffles 35 which house roller bearings 32 and 33 allow the upper and side walls to extend and retract on rails 132 and 133. Baffles 35 are preferably constructed with a strong metal or alloy. House roller bearings 32 and 33 are preferably constructed, as known in the art, to move a cube of baled material in a horizontal manner relative to the ground.

Also illustrated is horizontal movement cylinder 34, which in some embodiments is capable of moving top wall 110 horizontally in relation to rods or back bars 30 and front bar 60. In several embodiments of the present invention, top wall 110 is preferably designed of a durable metal material capable of being used in baling applications. Horizontal compression cylinder 34 is preferably constructed, as known in the art, to maintain the compression on a baled bale.

Attached to frame 40 are side baffles 137 which engage tubes 28 and 29 that are welded into the movable wall structure 20. These tube structures are to resist the torsional stress within the movable wall structure 20.

Also illustrated is horizontal cylinder 150A, which is in some embodiments is capable of moving side wall 130 away or towards frame 40. In several embodiments of the present invention, side wall 130 is preferably designed of a durable metal material capable of being used in bale movement applications. Placement of tubes 28 and 29 and cylinder 150A can vary as is known in the art.

Attached to adjustable support columns 20 are side baffles 137 which engage tubes 28 and 29. Also illustrated is horizontal cylinder 150B, which is some embodiments is capable of moving side wall 120 away or towards frame 100. Horizontal cylinder 150B is preferably constructed, as known in the art, to move a bale out or into an ejector. In several embodiments of the present invention, side wall 120 is preferably designed of a durable metal material capable of being used in baling applications. Cylinders 150A and 150B and can collectively be referenced as cylinder group or cylinders 150.

Attached to frame bars 61 and 31 is stationary floor wall 140. In several embodiments of the present invention, floor wall 140 is moveable or repositionable in relationship to the frame 100. In several embodiments of the present invention, floor wall 140 is preferably designed of a durable metal material capable of being used in baling applications. It is envisioned, that in several embodiments of the present invention, pistons and cylinders of variable size can be utilized and is known in the art for baling such that the pistons and cylinders have enough strength to move a bale. It is envisioned that side walls 120 and 130, top wall 110 and/or bottom wall 140 can be rotated in 90 degree increments relative to frame 40, such that in varying embodiments, any of side walls 120 and 130, top wall 110 and/or bottom wall 140 could be closest to the ground on which frame 100 rests.

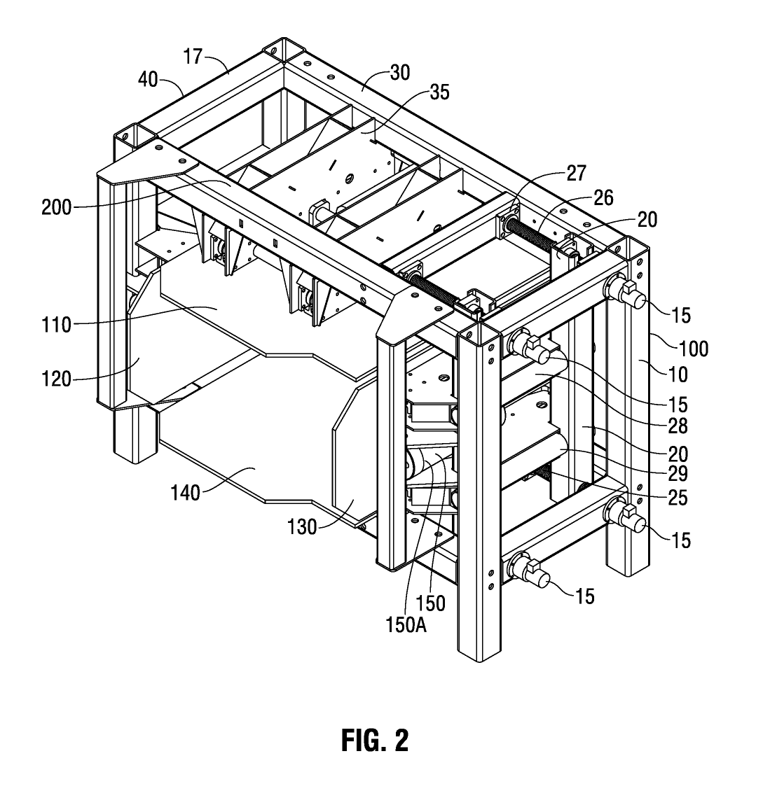

FIG. 2 is an isometric view of one embodiment of the present invention with a side wall 130 in the open position. In many embodiments of the present invention, adjustable support columns 20 can be in an “open position” wherein columns 20 are as close to frame 10 as possible while still being guided by threaded rods 25 and 26. It is envisioned that in several embodiments, rods 25 and 26 can actually be constructed as hydraulic cylinders or other motion devices capable of moving and maintaining columns 20. As shown in FIG. 2, walls 110, 120, 130 and 140 are in retracted position ready to receive a bale. Also shown is substantially rectangular front frame 200. Front frame 200 is preferably constructed of durable metal or an alloy.

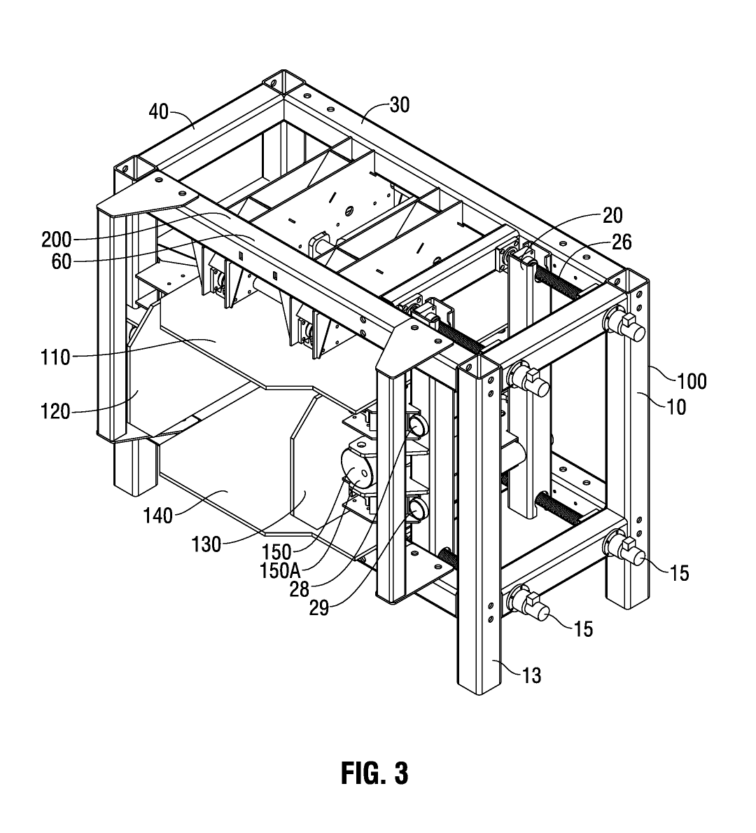

FIG. 3 is an isometric view of one embodiment of the present invention with the movable side wall 130 moved into the position for the completed bale to accommodate the bale size that has been baled. In many embodiments of the present invention, adjustable support columns 20 can be in a “ready position” wherein columns 20 are as far from frame 10 as necessary while still being guided by threaded rods 25 and 26 as to receive a bale for “walking”. As shown in FIG. 3, walls 110, 120, 130 and 140 are in retracted position ready to receive a bale. Cylinders 150 are not actuated at this time.

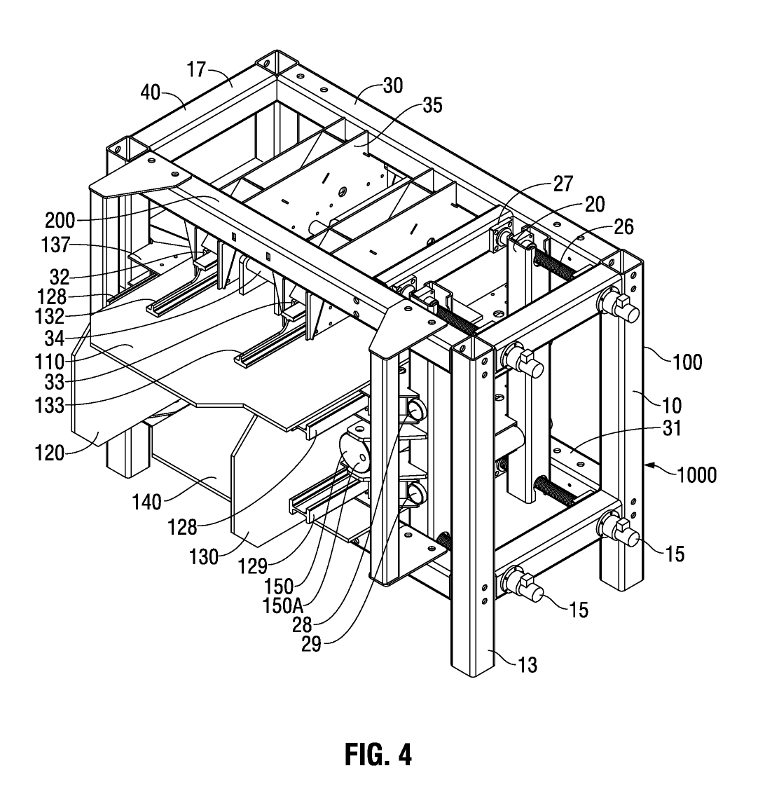

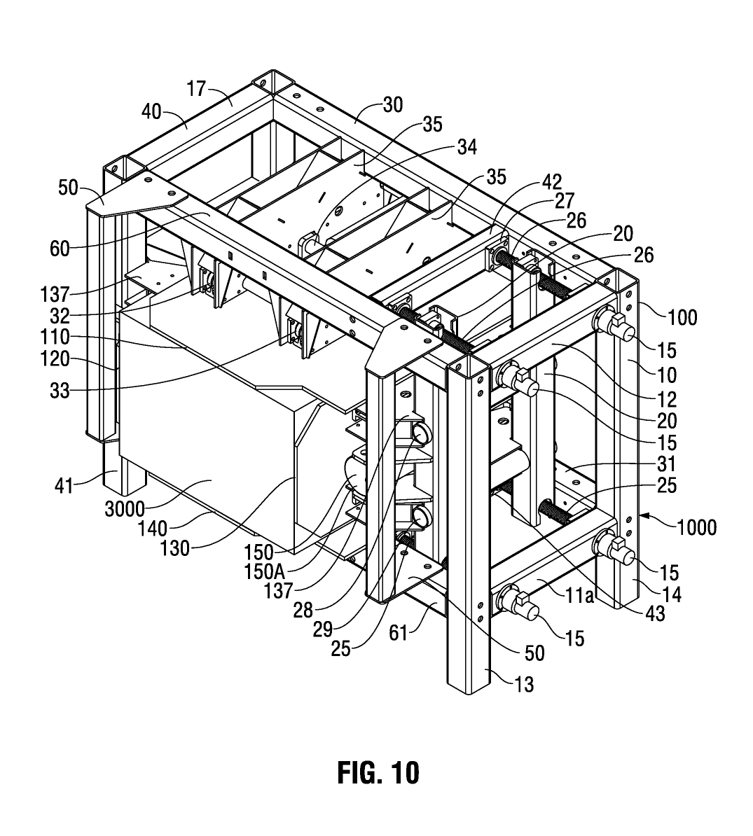

FIG. 4 is an isometric view of one embodiment of the present invention with all movable walls 110, 120, and 130 extended from the frame after a bale 3000 (FIG. 10) has been walked forward. In this figure of one embodiment of the present invention, side walls 120 and 130, as well as top wall 110 are in the full horizontal extension position. As shown, cylinder 34 is fully actuated so as to cause wall 110 to extend away from frame 100 along wall tracks 132 and 133 respectively. As shown, cylinders 150 are fully actuated so as to cause walls 120 and 130 to extend away from frame 100 along wall tracks 128 and 129 respectively.

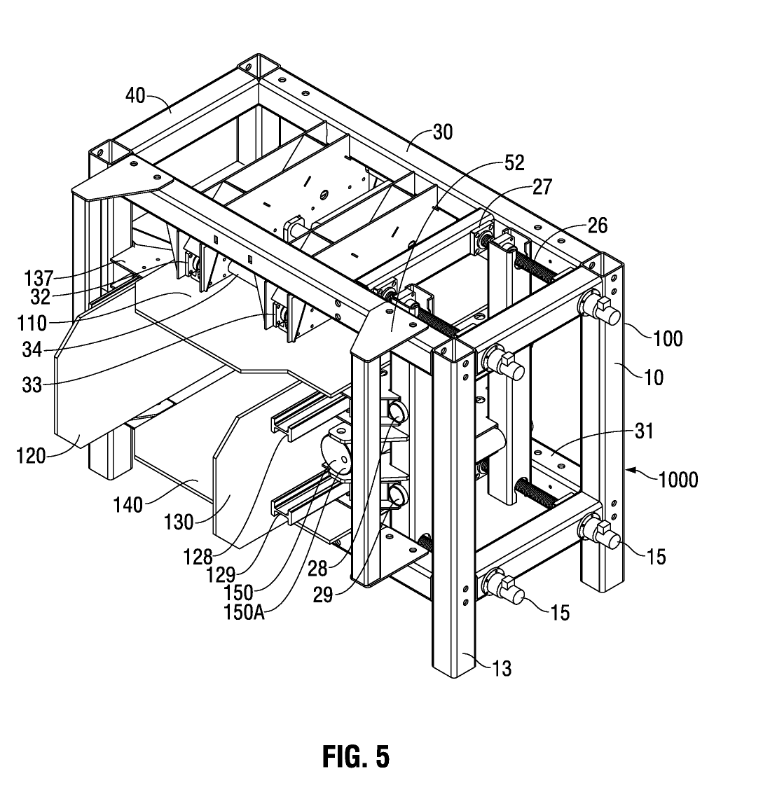

FIG. 5 is an isometric view of one embodiment of the present invention with the top wall moved back. In some embodiments of the present invention, top wall 110 can retract towards frame 100 upon retraction of cylinder 34 in order to walk another bale 3000 again.

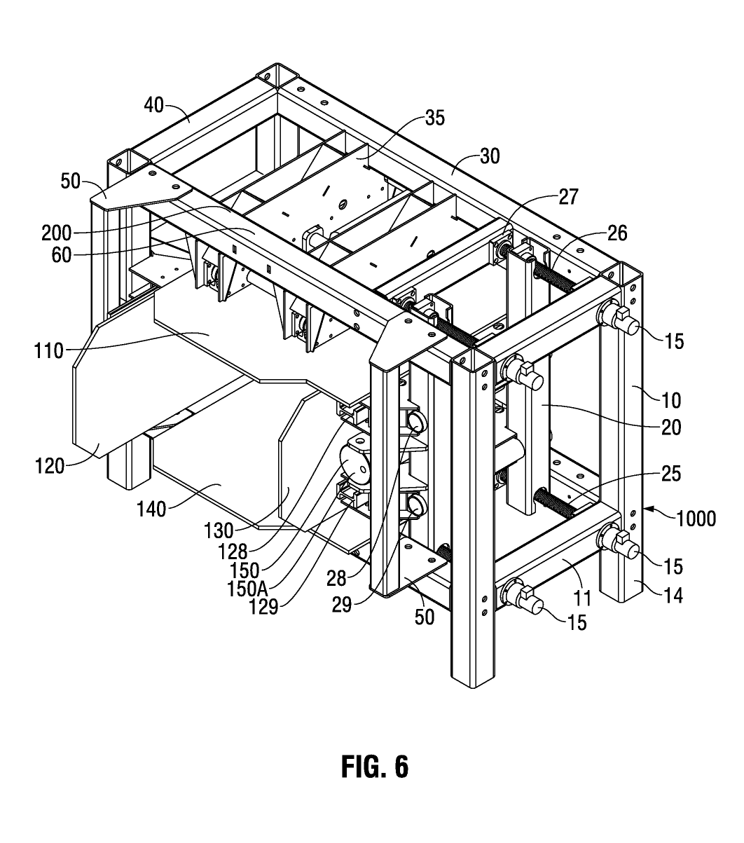

FIG. 6 is an isometric view of one embodiment of the present invention with a second wall (the adjusting side wall) moved back. In some embodiments of the present invention, side wall 130 can retract towards frame 100 upon retraction of cylinder 150B. It is envisioned that the actual retraction sequence of cylinder 34 as well as cylinders 150 can vary.

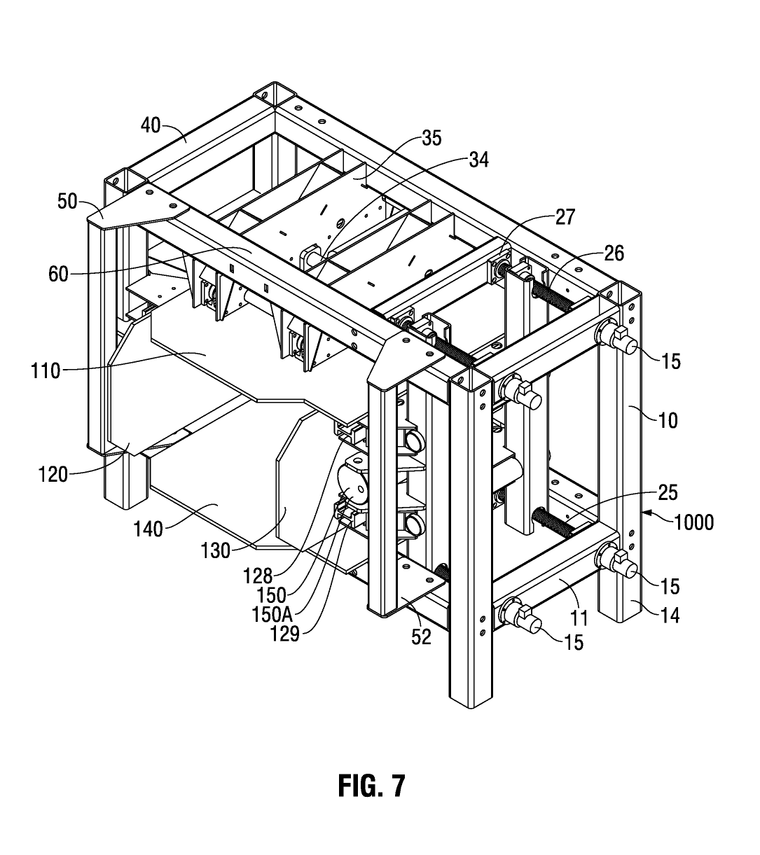

FIG. 7 is an isometric view of one embodiment of the present invention with a third wall (the stationary side wall) moved back. In some embodiments of the present invention, side wall 130 can retract towards frame 100 upon retraction of cylinder 150B. Once all walls as listed in FIGS. 4-7 have been retracted, the bale 3000 can be further walked forward relative to back bar 30.

FIG. 8 is an isometric view of one embodiment of the present invention with the adjustable wall 130 in the beginning operative position attached to a wire tier. As shown, wire tier assembly 2000 is attached to front frame 200 in a manner known in the art. Wire tier assembly 2000 can be one as known in the art for wire tying. Also, shown attached to frame 200 are push button control panel 90, feed tension unit 80, and knotter assembly 70. Push button control panel 90, feed tension unit 80, and knotter assembly 70 are of the types known in the art for wire tying. Control panel 90 can be modified to link the baler (not shown), ejector 1000, and wire tier assembly 2000 in a manner known in the art to ensure that the adjustable support columns are in the optimal position to obtain a bale 3000 and move said bale 3000 when in use. Control panel 90 is preferably designed to optimize baler and walking walls ejector 1000 performance and maximize the speed of baling and tying operations.

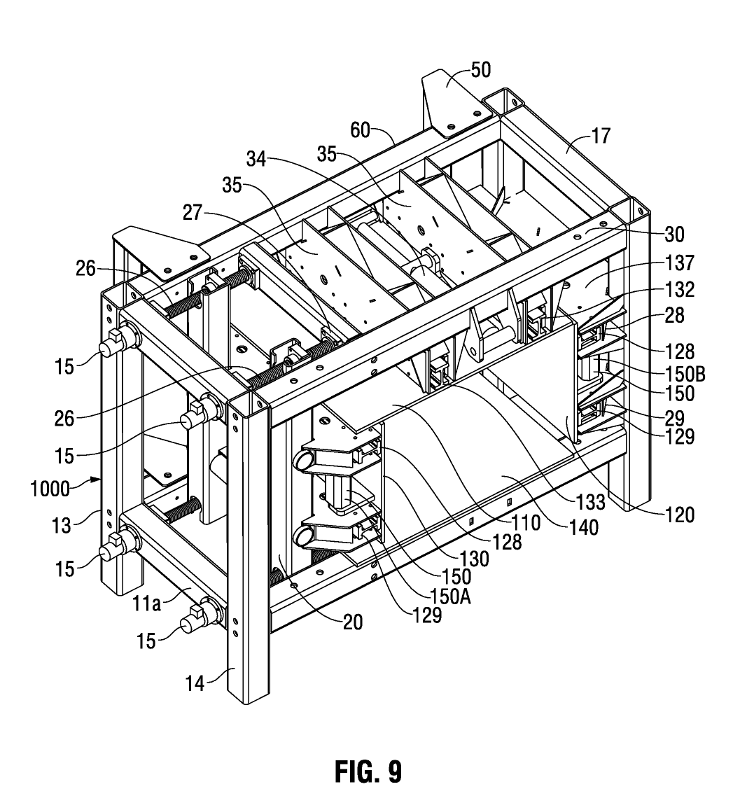

FIG. 9 is an isometric view of one embodiment of the present invention with the adjustable wall 130 in the beginning operative position as rotated from FIG. 1 to illustrate the back side of one embodiment of the present invention that will be adjacent and in communication with a baler. In this figure of one embodiment of the present invention, side walls 120 and 130, as well as top wall 110 are in the full horizontally retracted position relative to the back bar 30. As shown cylinder 150A is fully retracted so as to cause wall 120 to be proximate to back bar 30 along wall tracks 128 and 129 respectively. As shown, the other cylinders 34 and 150, are also in fully retracted positions. The bale 3000 upon leaving a baler will enter the walking walls ejector 1000 into the space formed by walls 110, 120, 130, and 140.

As also shown in FIG. 1, hollow frame 100 is constructed, in many embodiments, with two side frames 40 and 10. Frames 40 and 10 are preferably constructed in a rectangular shape with top bars 17 and 12 respectively and bottom bars 11 and 11a. In many embodiments, forming the sides of frame 40 and 10 are hollow square legs 14 and 13. In several embodiments, frames 40 and 10 also mechanically attach to frame bars 30, 31, 60 and 61 in a manner known in the art for a frame utilized in baling work. All frame bars and legs are preferably constructed of a durable metal or alloy material.

FIG. 10 is an isometric view of one embodiment of the present invention with the movable wall in the beginning operative position and a bale in the walking ejector. As illustrated, bale 3000 is horizontally moved by top wall 100 and side walls 120 and 130 through actuation of cylinder 34 and cylinder group 150.

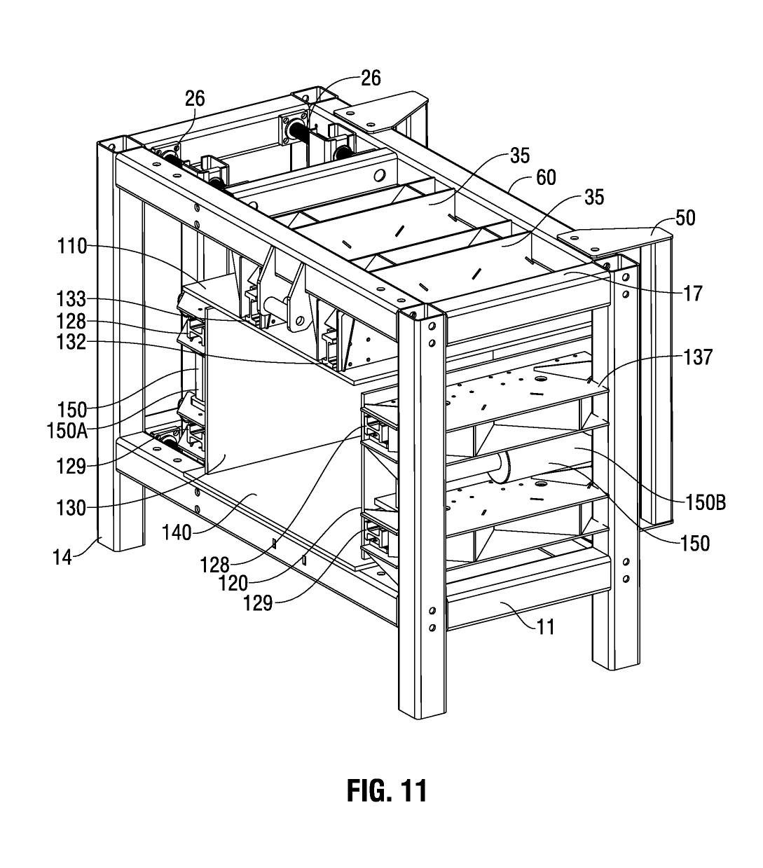

FIG. 11 is another isometric view of one embodiment of the present invention with the movable wall in the beginning operative position as rotated from FIG. 1 (approximately 180 degrees) to illustrate the back side of one embodiment of the present invention. In this figure of one embodiment of the present invention, side walls 120 and 130, as well as top wall 110 are in the full horizontally retracted position. As shown, house roller bearings 32 and 33 are fully retracted so as to cause wall 110 to be proximate to frame 100 along wall tracks 132 and 133 respectively. As shown, cylinder 150A is fully retracted so as to cause wall 120 to be proximate frame 100 along wall tracks 128 and 129 respectively. As shown other cylinders 34 and 150 are also in fully retracted positions.

In several embodiments, the present invention operates in the following manner: A bale 3000 is moved into the walking ejector 1000 (FIG. 9-11) from a baler. The compressed bale 3000 is then moved away from the back bar 30 by actuation of cylinders 150 and 34, therein causing walls 110, 120 and 130 to move forward relative to stationary floor wall 140. In some embodiments, upper wall 110 is then retracted (FIG. 5), followed by side wall 130 (FIG. 6) and then side wall 120 (FIG. 7). This retraction therein advances the bale 3000 through the ejector by “walking” it. In several embodiments (FIG. 8), the walked bale 3000 is then tied by wire tier assembly 2000 in a manner known in the art. This operation of walking walls ejector 1000 can continue until the entire bale 3000 is passed through the ejector 1000 and (potentially) tied at various intervals.

In some embodiments the present invention is a walking walls bale ejector 1000 comprising: a frame 100 with back bars 30 and front bars 30 forming an interior comprising; a laterally and horizontally moveable first side wall 130 capable of movement in relation to said back bars 30; a horizontally moveable second side wall 120 capable of movement in relation to said back bars 30; a horizontally moveable top wall 110 capable of movement in relation to said back bars 30; a bottom floor 140 which is stationary in relation to said back bars 30.

In some embodiment of the present invention, the walking walls bale ejector 1000 has first side wall 130, said second side wall 120 and said top walls 110 that are capable of horizontal movement away from said back bar 30. In some embodiment of the present invention, the walking walls bale ejector 1000 has first side wall 130, said second side wall 120 and said top wall 110 that are capable of horizontal movement towards said back bar 30.

In some embodiments, said horizontal movement of said first side wall 130, said second side wall 120 and top wall 110 occurs through simultaneous actuation of said first side wall 130, said second side wall 120 and said top wall 110. In some embodiments, a moveable or adjustable column assembly 20 located in said frame 1000 and is attached in mechanical communication to said first side wall 130. In some embodiments, the moveable column 20 is attached and in electronic communication with a baler to ensure bale 3000 size compatibility. In some embodiments, said front bars 60 are in mechanically attached to a wire tier 2000. In several embodiments, said side wall 130 capable of movement in relation to said back bars 30 is actuated by a first horizontal cylinder 150A for horizontal motion; second side wall 120 capable of movement relation to said back bars is actuated by a second horizontal cylinder 150B for horizontal motion; top wall 110 capable of movement in relation to said back bars is actuated by a third horizontal cylinder 34 for horizontal motion.

In several embodiments, the present invention is a method for moving a bale 3000 through a walking walls bale ejector 1000 comprising: ejecting a bale 3000 into a walking walls bale ejector 1000 which comprises: a frame 100 with an interior comprising; a moveable first side wall 130 capable of movement in relation to said frame 100; a moveable second side wall 120 capable of movement in relation to said frame 100; a moveable top wall 110 capable of movement horizontally in relation to said frame 100; a bottom floor 140 which is stationary in relation to said frame 100; and horizontally moving a bale 3000 through actuation of said first side wall 130, said second side wall 120 and said top wall 110. In several embodiments, there is an additional step of providing a walking walls bale ejector 1000 which further comprises an adjustable column assembly 20 located in said frame 1000 and attached in mechanical communication to said first side wall 130. In several embodiments, the method further comprises the step of attaching a wire tier to said front bars of said frame; and wire tying a bale as it exits the walking walls ejector.

In several embodiments, the present invention is a walking walls bale ejector 1000 comprising: a frame 100 with an interior comprising; a moveable first side wall 130 with a horizontal first side wall horizontal movement cylinder 150A and lateral moveable first side wall 130, wherein said moveable first side wall 130 is capable of movement horizontally and laterally in relation to said frame 100; a horizontal moveable second side wall 120 with a horizontal second side wall movement cylinder 150B, wherein said horizontal moveable second side wall 120 is capable of movement horizontally in relation to said frame 100; a horizontal moveable top wall 110 with a top wall horizontal movement cylinder 34, wherein said horizontal moveable top wall 110 is capable of movement horizontally in relation to said frame 100; and a bottom floor 140 which is stationary in relation to said frame 100, wherein said first side wall 130 with a lateral first side wall and a first side wall horizontal movement cylinder 150A is capable of horizontal and lateral movement when actuated relative to said bottom floor 140; said second side wall 120 with horizontal second side wall movement cylinder 150B is capable of horizontal movement when actuated relative to said bottom floor 140; and said top wall 110 with top wall horizontal movement cylinder 34 is capable of horizontal movement when actuated relative to said bottom floor 140.

In several embodiments, said first side wall 130 with a first side wall horizontal movement cylinder 150A, said second side wall 120 with a second side wall horizontal movement cylinder 150B, and said top wall 110 with a top wall horizontal movement cylinder 34 are capable of horizontally moving a bale 3000 through actuation of said first side wall horizontal movement cylinder 150A, said second side wall horizontal movement cylinder 150B, and said top wall horizontal movement cylinder 34. In several embodiments, actuation of said first side wall horizontal movement cylinder 150A, said second side wall horizontal movement cylinder 1503 and said top wall horizontal movement cylinder 34 occurs through simultaneous actuation of said first side wall horizontal movement cylinder 150A, said second side wall movement cylinder 150B and said top wall movement cylinder 34.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

What is claimed is the following:

1. A walking walls bale ejector comprising:
a frame with back bars and front bars forming an interior comprising;
a moveable first side wall capable of movement in relation to said frame;
a moveable second side wall capable of movement in relation to said frame;
a moveable top wall capable of movement in relation to said frame;
a bottom floor which is stationary in relation to said frame.

2. The walking walls bale ejector of claim 1, wherein
said first side wall, said second side wall and said top wall are capable of horizontal movement away from said frame.

3. The walking walls bale ejector of claim 1, wherein
said first side wall, said second side wall and said top wall are capable of horizontal movement towards said frame.

4. The walking walls bale ejector of claim 1 wherein
said horizontal movement of said first side wall, said second side wall and said top wall occurs through simultaneous actuation of said first side wall, said second side wall and said top wall.

5. The walking walls bale ejector of claim 1 further comprising:
a moveable column assembly located in said frame and attached in mechanical communication to said first side wall.

6. The walking walls bale ejector of claim 5 wherein;
said moveable column is attached and in electronic communication with a baler to ensure bale size compatibility.

7. A walking walls bale ejector of claim 1 further comprising:
said front bars are mechanically attached to a wire tier.

8. A walking walls bale ejector of claim 1 further comprising;
said side wall capable of movement in relation to said back bars is actuated by a first horizontal cylinder for horizontal motion;
a second side wall capable of movement in relation to said back bars is actuated by a second horizontal cylinder for horizontal motion;
a moveable top wall capable of movement in relation to said back bars is actuated by a third horizontal cylinder for horizontal motion.

9. A method for moving a bale through a walking walls bale ejector comprising:
ejecting a bale into a walking walls bale ejector which comprises:
a frame with an interior comprising;
a moveable first side wall capable of movement in relation to said frame;
a moveable second side wall capable of movement in relation to said frame;
a horizontally moveable top wall capable of movement horizontally in relation to said frame;
a bottom floor which is stationary in relation to said frame; and
horizontally moving a bale through actuation of said first side wall, said second side wall and said top wall.

10. The method of claim 9 further comprising the step of:
providing a walking walls bale ejector which further comprises an adjustable column assembly located in said frame and is attached in mechanical communication to said first side wall.

11. The method of claim 10 further comprising the step of:
providing a walking walls bale ejector in which said adjustable column is attached and in electronic communication with a baler to ensure bale size compatibility.

12. The method of claim 9 further comprising the step of:
attaching a wire tier to said front bars of said frame; and
wire tying a bale as it exits the walking walls ejector.

13. A walking walls bale ejector comprising:
a frame with an interior comprising;
a moveable first side wall with a horizontal first side wall movement cylinder and lateral moveable first side wall, wherein said lateral and horizontal moveable first side wall is capable of movement horizontally and laterally in relation to said frame;
a moveable second side wall with a horizontal second side wall movement cylinder, wherein said horizontal moveable second side wall is capable of movement horizontally in relation to said frame;
a moveable top wall with a horizontal top wall movement cylinder, wherein said horizontal moveable top wall is capable of movement horizontally in relation to said frame; and
a bottom floor which is stationary in relation to said frame, wherein
said moveable first side wall with a horizontal first side wall movement cylinder is capable of horizontal and lateral movement when actuated relative to said bottom floor;
said moveable second side wall with horizontal second side wall movement cylinder is capable of horizontal movement when actuated relative to said bottom floor; and
said moveable top wall with top wall movement cylinder are capable of horizontal movement when actuated relative to said bottom floor.

14. The walking walls bale ejector of claim 13 wherein said moveable first side wall with a horizontal first side wall movement cylinder, said second side wall with a horizontal second side wall movement cylinder, and said top wall with a horizontal top wall movement cylinder is capable of horizontally moving a bale through actuation of said horizontal first side wall cylinder, said horizontal second side wall cylinder and said top wall horizontal movement cylinder.

15. The walking walls bale ejector of claim 14 wherein said horizontal movement of a bale through actuation of said horizontal first side wall movement cylinder, said horizontal second side wall movement cylinder and said top wall movement piston occurs through simultaneous actuation of said horizontal first side wall movement cylinder, said horizontal second side wall movement cylinder and said top wall movement cylinder.

16. The walking walls bale ejector of claim 13 further comprising:
a moveable column assembly located in said frame, wherein said first moveable side wall with a horizontal first side wall movement cylinder is moveable in relation to said frame on said moveable column assembly in said frame.

17. The walking walls bale ejector of claim 16, wherein said moveable column assembly in said frame is attached and in electronic communication with a baler to ensure bale size compatibility.

18. A walking walls bale ejector of claim 13 further comprising:
said frame further mechanically attached to a wire tie.
